(19) United States
(12) Patent Application Publication
(10) Pub. No.: US 2016/0079872 A1
(43) Pub. Date: Mar. 17, 2016

(54) POWER CONVERTER

(71) Applicant: Samsung Electro-Mechanics Co., Ltd., Suwon-Si (KR)

(72) Inventors: Dong Kyun RYU, Seoul (KR); Gie Hyoun KWEON, Hwaseong-si (KR); Sang Kyoo HAN, Daejeon-si (KR)

(73) Assignee: SAMSUNG ELECTRO-MECHANICS CO., LTD., Suwon-Si (KR)

(21) Appl. No.: 14/847,340

(22) Filed: Sep. 8, 2015

(30) Foreign Application Priority Data
Sep. 12, 2014 (KR) 10-2014-0121214
Dec. 15, 2014 (KR) 10-2014-0180174

(51) Int. Cl. H02M 3/335

(52) U.S. Cl. CPC H02M 3/33546

(57) ABSTRACT

In an embodiment of the present invention, a power converter for applying a voltage to a load having at least one channel includes a power supply for storing and outputting a floating voltage lower than a forward voltage of the channel and a converter for receiving and converting a link voltage to generate a first voltage, thereby transmit the voltage higher than the forward voltage of the channel.

### CROSS-REFERENCE TO RELATED APPLICATIONS

Claim and incorporate by reference domestic priority application and foreign priority application as follows:

### “CROSS REFERENCE TO RELATED APPLICATION

This application claims the foreign priority benefit under 35 U.S.C. Section 119 of Korean Patent Application Serial Nos. 10-2014-0121214 and 10-2014-0180174, entitled filed Sep. 12, 2014 and Dec. 15, 2014, which are hereby incorporated by references in its entirety into this application.”

### BACKGROUND OF THE INVENTION

1. Field of the Invention

Embodiments of the present invention relates to a power converter.

2. Description of the Related Art

Various research and developments relating to high technical electronic display devices have progressed on the occasion of recent digital and multimedia broadcasting day. The market of a flat panel display (FPD) among them is rapidly growing. A field emission display (FED) includes a thin film transistor liquid crystal display (TFT LCD), a plasma display panel (PDP), an organic electroluminescence (EL) or the like. Recently, FED with a large screen has been widely supplied, and accordingly a main unit, the backlight, also has been developed at the same time. In addition, a switch mode power supply (SMPS) is also still required to have a 200 W-grade or higher, light, thin and larger capacitor. In particular, in LCD, among FEDs, it is essential to use a backlight unit (BLU) to supply the light of uniform brightness over the entire area of LCD as it is not a self-emitting display. However, BLU is a large unit of the panel costs and it also uses approximately 90% of the power consumption in an LCD panel. Accordingly, various researches have been done to provide a high definition LCD TV, having improved efficiency while maintaining the competitive price of the LCD.

The brightness of the LCD with a backlight has improved from a notebook PC screen with a brightness of 70 cd/m² early to an LCD TV to 450 cd/m² now. A target brightness of an LCD TV in the future will be 600 cd/m² or more. The required unit to increase the brightness of the TFT LCD is a backlight and its surface brightness is progressing from a monitor to an LCD TV while it is required to have a value from about 1,000 cd/m ² to 10,000 cd/m². Moreover, currently the size of the TFT LCD has gradually increased and an advanced brightness is steadily requested and thus the importance of the backlight has gradually increased.

### SUMMARY OF THE INVENTION

An object of the present invention is to provide a power converter with low voltage stress by applying low driving voltage.

Another object of the present invention is to provide a power converter with small size.

In accordance with a first embodiment of the present invention, a power converter for applying a voltage to a load including at least one channel may comprise a power supply for storing and outputting a floating voltage lower than a forward voltage of the channel; and a converter for transmitting the voltage higher than the forward voltage of the channel to the load by receiving and converting the link voltage and generating the first voltage.

In accordance with a second embodiment of the present invention, a power converter for applying a voltage to a load including at least one channel may comprise a capacitor in serial connected to the channel; a converter for dividing an input voltage into a link voltage and a floating voltage lower than a forward voltage of the channel and converting the link voltage and adjusting an input voltage into the capacitor, wherein the converter enables the first voltage to apply to the capacitor on stopping and a voltage lower than the forward voltage of the channel to apply to the channel, and the second voltage to charge to the capacitor by discharging the first voltage on driving and a voltage higher than the forward voltage of the channel to apply to the channel.

Due to the power converter in accordance with the present invention, it is possible to reduce the load of switches by decreasing voltage stress in the converter for supplying the current to the light-emitting diode and reduce the number of switches by not requiring a separate dimming switch for each channel. It is also possible to decrease the volume of the capacitor and save production cost by using a constant current control.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a circuit diagram showing a power converter;

FIG. 2 is a circuit diagram showing a first embodiment of a converter unit of a power converter shown in FIG. 1;

FIG. 3 is a circuit diagram showing a second embodiment of the converter unit of a power converter shown in FIG. 1;

FIG. 4 is a circuit diagram showing a first embodiment of a converter unit of a power converter according to the present invention;

FIG. 5 is a view showing the relationship among the output of the converter, the driving voltage and the forward voltage of the light-emitting element in the converter unit shown in FIG. 4;

FIG. 6 is a circuit diagram showing a second embodiment of the converter unit according to the present invention;

FIG. 7 is a view showing the relationship between the output of the converter, the driving voltage and the forward voltage of the light-emitting element in the converter unit shown in FIG. 6;

FIG. 8 is a timing diagram showing the operation of the converter unit shown in FIG. 6;

FIG. 9 is a circuit diagram showing a third embodiment of the power converter according to the present invention;

FIG. 10 is a circuit diagram showing a first embodiment for driving the serial single channel from the power converter shown in FIG. 9;

FIG. 11 is a circuit diagram showing a fourth embodiment of the power converter according to the present invention;

FIG. 12 is a circuit diagram showing a first embodiment for driving the serial single channel from the power converter shown in FIG. 11;

FIG. 13 is a circuit diagram showing a first embodiment of converter unit cap balancing using a capacitor in the two channels;

FIG. 14 is a circuit diagram showing a second embodiment of converter unit cap balancing using a capacitor in the two channels;

FIG. 15 is a circuit diagram showing a first embodiment of converter unit cap balancing using a capacitor in the three channels;

FIG. 16 is a circuit diagram showing a second embodiment of converter unit cap balancing using a capacitor in the three channels;

FIG. 17 is a graph showing the experimental results in the case where a low-side buck converter is applied to a secondary-side of an LLC;

FIG. 18 is a graph showing the experimental results in case where a booster converter is applied to the secondary-side of the LLC; and

FIG. 19 is a graph showing the experimental results in case where a low-side buck converter is applied to the secondary-side of the LLC and cap balancing using a capacitor in two channels.

### DETAILED DESCRIPTION OF THE PREFERABLE EMBODIMENTS

Matters regarding the operational effect including the technical configuration for an object of a power converter using the same in accordance with the present invention will be clearly appreciated through the following detailed description with reference to the accompanying drawings showing preferable embodiments of the present invention.

Further, in describing the present invention, descriptions of well-known techniques are omitted so as not to unnecessarily obscure the embodiments of the present invention. In the present specification, the terms “first,” “second,” and the like are used for distinguishing one element from another, and the elements are not limited by the above terms.

In the following detailed description of the present invention, reference is made to the accompanying drawings that show, by way of illustration, specific embodiments in which the present invention may be practiced. These embodiments are described in sufficient detail to enable those skilled in the art to practice the embodiments. It is to be understood that the various embodiments, although different, are not necessarily mutually exclusive. For example, a uniticular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments. The following detailed description is, therefore, not to be taken in a limiting sense, and the scope of the embodiments is defined only by the appended claims, appropriately interpreted, along with the full range of equivalents to which the claims are entitled. In the drawings, like numerals refer to the same or similar functionality throughout the several views.

Hereinafter, embodiments of the present invention will be described in detail with reference to the accompanying drawings so that those skilled in the art can easily practice the present invention.

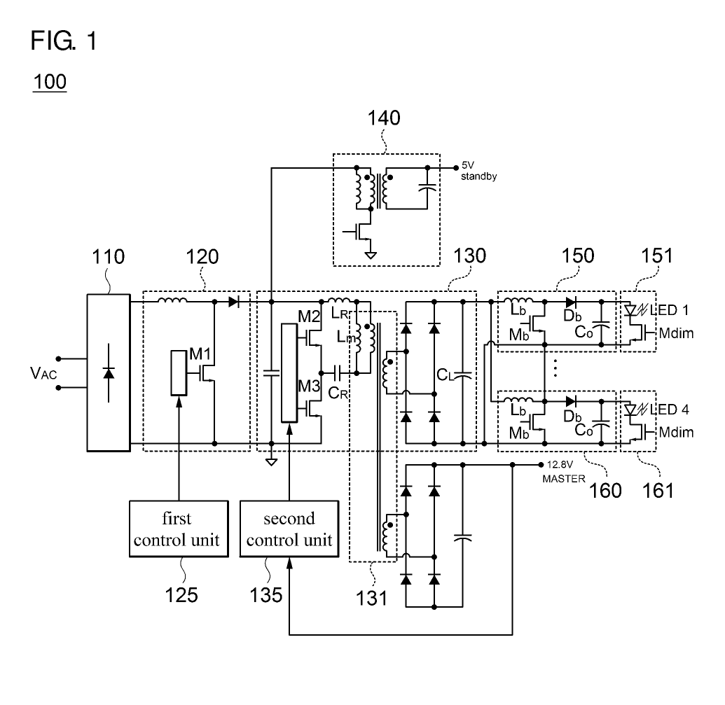

FIG. 1 is a circuit diagram showing a power converter.

Referring to FIG. 1, a power converter 100 may include a rectifier unit 110, a converter unit 130, a flyback converter 140, a first post regulator 150 and a second post regulator 160. The power converter 100 can be provided for electronic products such as TV, etc, and the power converter 100 can output approximately 150 V voltage for driving LED 1 and LED 2 so as to emit the light from the light-emitting elements, 12.8V voltage for audio and 5 V for image board and Standby. That is, the power converter 100 can output one alternating current into various voltages through a plurality of output terminals. The power converter 100 can rectify and input the alternating current at the rectifier unit 110. A PFC (power factor correction) 120 can receive input DC and can precisely control the inputted 385 V DC by using master of 12.8V output via the converter unit 130 and the output voltage for driving the LED cannot be controlled as a slave and output into a predetermined voltage by the turn ratio of the transformer 131. The power converter 100 may comprise an LLC. The voltage output at the converter unit 130 is regulated by using the first post regulator 150 and the second post regulator 160 and the voltages are applied to first channel 151 and second channel 152 including LED 1 and LED 2 and can be precisely controlled respectively. The first post regulator 150 and the second post regulator 160 may be a buck converter or a boost converter. But they are not limited to only those.

Each of the PFC 120 and the converter unit 130 may comprise a first control unit 125 and a second control unit 135 and some operations can be controlled by the first control unit 125 and second control unit 135. In addition, the power converter is shown to include two channels 151 and 161, but is not limited thereto and the corresponding number of the channels can determine the number of post regulator(s). In addition, 5 V for image using the separate flyback converter 140 can output board and Standby.

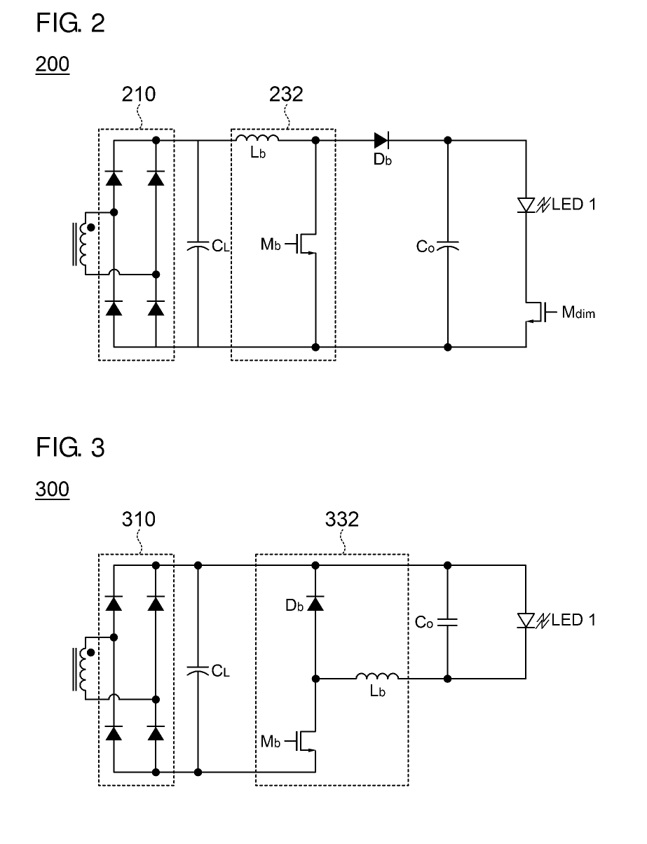

FIG. 2 is a circuit diagram showing a first embodiment of the converter unit of a power converter shown in FIG. 1

Referring to FIG. 2, the converter unit 200 is intended to connect a separate converter to a secondary side of the converter unit 130 shown in FIG. 1 and to precisely control a voltage applied to the channel, and the converter unit 200 may include a rectifier unit 210 and converter 232. The converter 232 may comprise an inductor (L_{b}), a switch (M_{b}) and a diode (D_{b}). In addition, the converter 232 may be a booster converter. The converter 200 can rectify a predetermined voltage by a rectifier unit 210 and charge a voltage lower than the driving voltage (V_{LED}) of LED to capacitor (C_{L}) and the converter 232 can boost the voltage charged at the capacitor to the driving voltage and drive the LED. This approach may need a separate dimming switch (M_{dim}) for dimming, wherein the dimming adjusts the amount of current passing through the channel and control the brightness. The switch (M_{b}) and the dimming switch (M_{dim}) may be a MOSFET (Metal oxide silicon field effect transistor), a BJT (Bipolar junction transistor), or a FET (Field effect transistor).

At this time, the switch (M_{b}) and the diode (D_{b}) can have a high voltage stress corresponding to the voltage of LED. In particular, the converter unit 200 can increase the driving voltage of LED so that the received stresses in switch (M_{b}) and the diode (D_{b}) can be increased more if the driving voltage is applied to electronic products with high voltage.

FIG. 3 is a circuit diagram showing a second embodiment of the converter unit of a power converter shown in FIG. 1

Referring to FIG. 3, a converter unit 300 is intended to provide a low side buck converter for a secondary side of the converter unit 130 shown in FIG. 1 and the converter unit 300 may comprise a rectifier unit 310 and converter 332. The converter 232 may comprise an inductor (L_{b}), a switch (M_{b}) and a diode (D_{b}). The switch (M_{b}) as a switch of the buck converter can control the flow of current flowing through the inductor as well as adjust the amount of the current and thereby can operate as a switch for dimming. Therefore, the converter unit 300 can have an advantage of not requiring a separate dimming switch.

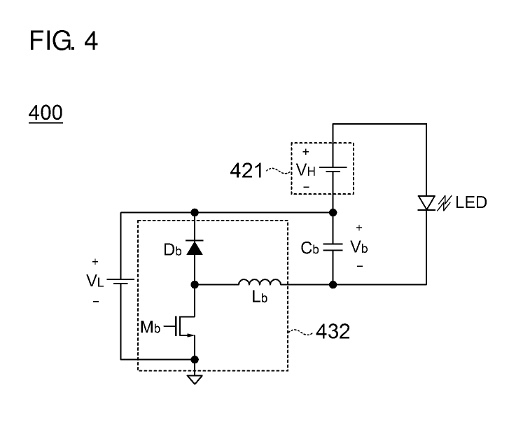

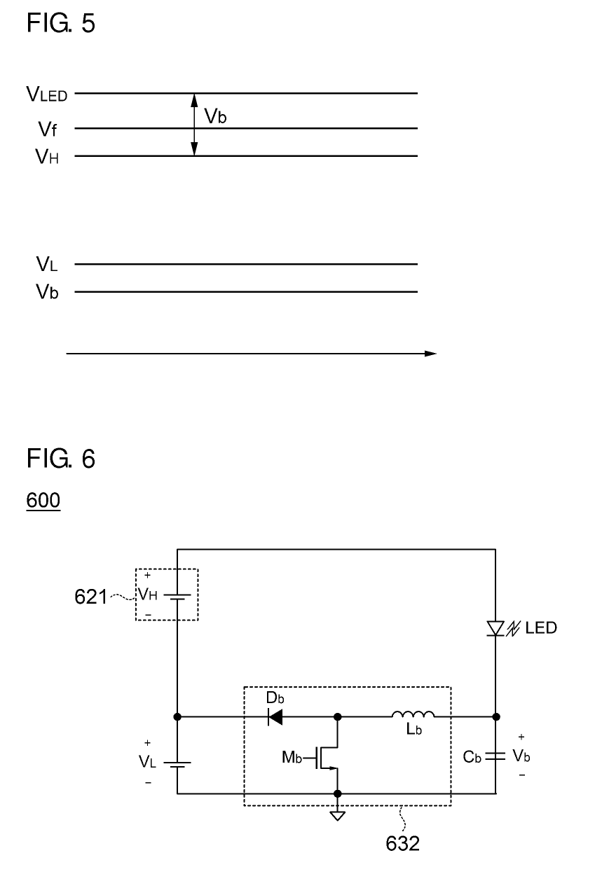

FIG. 4 is a circuit diagram showing a first embodiment of the converter unit according to the invention and FIG. 5 is a view showing the relationship between the output of the converter, the driving voltage and the forward voltage of the light emitting element in the converter unit shown in FIG. 4.

Referring to FIGS. 4 and 5, a converter unit 400 may comprise a power supply 410 for storing and outputting the floating voltage (Vₕ) lower than the forward voltage of the channel; and a converter 432 for receiving and converting the link voltage (V_{L}) and generating the first voltage. In addition, the converter 432 can transmit a summed voltage of the floating voltage (Vₕ) and the first voltage to a load. If the floating voltage (Vₕ) and the first voltage are summed up, the summed voltage can be a higher voltage than the forward voltage of the channel. The floating voltage (Vₕ) can set up lower than the forward voltage (V_{f}) as shown in FIG. 5 so that when the voltage (V_{b}) in the capacitor (C_{b}) in which the output of the converter 432 is stored is zero, only the floating voltage (Vₕ) is applied to the LED and thus enable the current to not flow through the LED; and the voltage (V_{b}) charged to the capacitor (C_{b}) can have the first voltage by operating of the converter 432. Here, the first voltage may be represented as shown in equation 1 below.

V1=V_{LED}−V_{H} [Equation 1]

Herein, V1 can stand for a voltage level of the first voltage charged at the capacitor (C_{b}), V_{LED} can stand for a voltage level of the driving voltage of LED and V_{H} can stand for a voltage level of the floating voltage.

And, when the first voltage such as the Equation 1 is charged to the capacitor (C_{b}), the summed voltage of the floating voltage (Vₕ) and the first voltage is applied to the LED, and thus the driving voltage (V_{LED}) can be applied to the summed driving voltage (V_{LED}).

Therefore, the converter 432 can control the current flowing through the LED by not regulating all the driving voltage (V_{LED}) of the LED but regulating the link voltage (V_{L}) lower than the driving voltage (V_{LED}). Herein, the converter 432 may comprise a buck converter. In addition, it is preferable when the voltage corresponding to the difference of the floating voltage (Vₕ) from the driving voltage (V_{LED}) is stored to the capacitor (C_{b}), the link voltage (V_{L}) of the converter 432 can be a very lower voltage than the driving voltage (V_{LED}). Accordingly, the voltage stress applied to the switch (M_{b}) and the diode (D_{b}) of the converter 432 can be significantly reduced. In addition, the switch (M_{b}) of the converter 432 can control the current flowing through the LED so that it is possible to implement a smaller volume of the capacitor (C_{b}) than the process of controlling a voltage.

On the supposition that the driving voltage (V_{LED}) of the LED is 200V, the forward voltage (V_{f}) of the LED is 170 and maximum operation duty ratio of the converter 432 is 0.8, in the case of a typical converter, it can be required 200/0.8=250V as an input voltage for driving the LED. Therefore, the voltage stress applying to the switch (M_{b}) and the diode (D_{b}) can be 250V. However, if the maximum operation duty ratio of the converter 432 is 0.8 as shown in the above, the link voltage (V_{L}) of the converter 432 can be required 62.5V. Therefore, it can be seen that the voltage stress applied to the switch (M_{b}) and the diode (D_{b}) of the converter 432 shown in FIG. 4 can be significantly reduced to 62.5V.

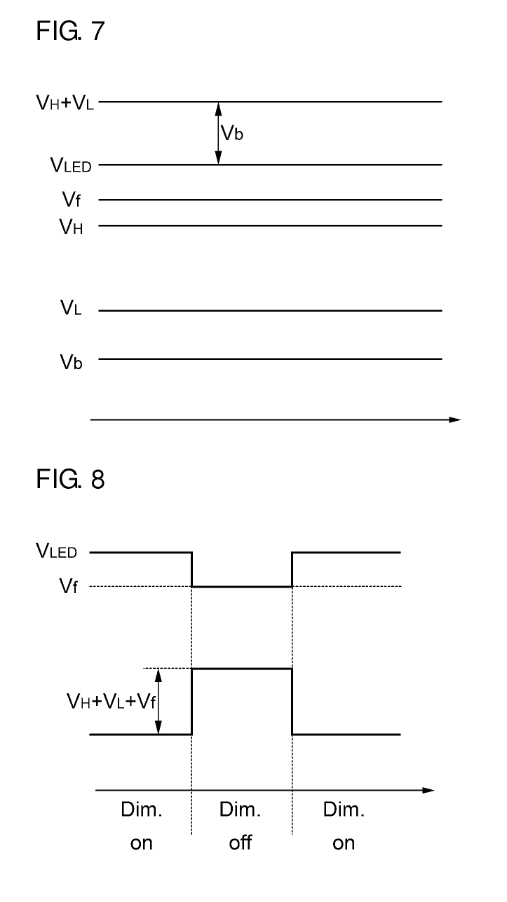

FIG. 6 is a circuit diagram showing a second embodiment of the converter unit according to the invention and FIG. 7 is a view showing the relationship among the output of the converter, the driving voltage and the forward voltage of the light emitting element in the converter unit shown in FIG. 6, and FIG. 8 is a timing diagram showing the operation of converter unit shown in FIG. 6.

Referring to FIGS. 6 to 8, a converter unit 600 may comprise a capacitor (C_{b}) for applying a voltage to the load comprising at least one channel and connecting in serial to the LED contained within the channel; and a converter 632 for dividing an input voltage into the link voltage (V_{L}) and the floating voltage (V_{f}) and converting the link voltage (V_{L}) and adjusting the input voltage into the capacitor (C_{b}). In addition, the converter 632 enables first voltage to apply to the capacitor (C_{b}) on stopping and a voltage lower than the forward voltage of the channel to apply to the channel, and second voltage to charge to the capacitor (C_{b}) by discharging the first voltage on driving and a voltage corresponding to the summed voltage of the floating voltage (Vₕ) and the link voltage (V_{L}) higher than the forward voltage of the channel to apply to the channel. The summed voltage of the floating voltage (Vₕ) and the link voltage (V_{L}) may be an input voltage. In addition, the converter 632 may be a booster converter.

The converter 632, if it is not operated, enables the LED to turn off so as to apply a voltage lower than the forward voltage (V_{f}) to the LED by increasing the voltage (V_{b}) charged to the capacitor (C_{b}) over the voltage corresponding to the equation 2 as shown below in the voltage waveform of FIGS. 7 and 8.

V_{b}=V_{H}+V_{L}−V_{f} [Equation 2]

Herein, V_{b} stands for a voltage level charged to the capacitor (C_{b}), V_{H} stands for a voltage level of the floating voltage (Vₕ), VL stands for a voltage level of link voltage (V_{L}), and V_{f} may be a voltage level of the forward voltage.

In addition, if the converter 632 is operated, the charges charged to the capacitor (C_{b}) are discharged from the converter 632, and thereby the driving voltage (V_{LED}) is applied to the LED, decreasing the voltage can drive the LED charged to capacitor (C_{b}) into the voltage shown in equation 3.

V_{b}=V_{LED}−V_{H}−V_{L} [Equation 3]

Herein, V_{b} stands for a voltage level charged to the capacitor (C_{b}), and V_{LED} stands for a voltage level of the driving voltage of the LED, V_{H} stands for a voltage level of the floating voltage, and V_{L} stands for a voltage level of link voltage.

Since the converter unit 600 which is configured as described above has the link voltage (V_{L}) much lower than the driving voltage (V_{LED}), the present invention also has an advantage of sufficiently decreasing the voltage stress applied to all the elements of the converter unit 600. In addition, the converter unit 600 can control the current flowing through the LED so that it is possible to implement a smaller volume of the capacitor (C_{b}) than the process of controlling a voltage.

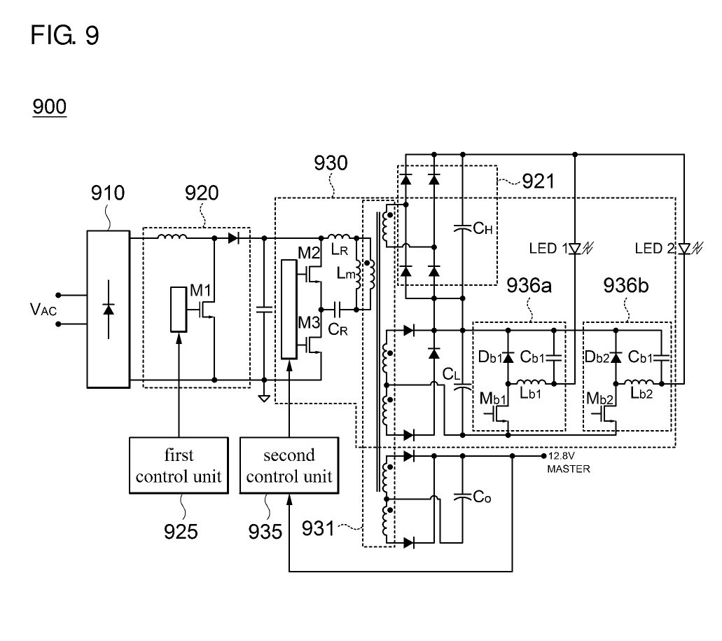

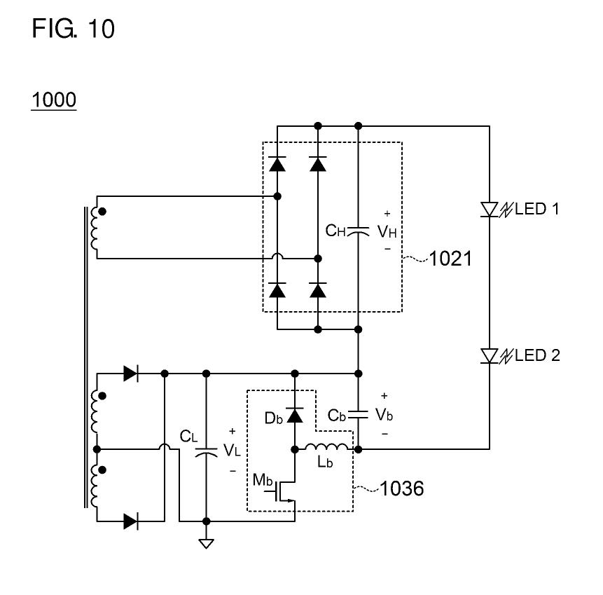

FIG. 9 is a circuit diagram showing a third embodiment of the power converter according to the present invention, and FIG. 10 is a circuit diagram showing a first embodiment for driving the serial single channel from the power converter shown in FIG. 9.

Referring to FIGS. 9 and 10, a power converter 900 may comprise a rectifier unit 910, PFC 920 and a converter unit 930. In addition, the power converter 900 can supply power to a plurality of channels connected in parallel. The plurality of channels may comprise LED 1 and LED 2 respectively. The converter unit 930 may comprise an LLC converter, but is not limited thereto. The converter unit 930 may comprise a transformer 931, and a low side buck converter 936a and 936b may be provided with secondary side windings of the transformer 931. The number of the low side buck converters 936a and 936b can be corresponded to the number of channels. In addition, the converter unit 930 is formed on the secondary side windings and may comprise a voltage supply unit 921 for applying the floating voltage NO. The voltage supply unit 921 may comprise a rectifier unit including a diode and a capacitor (C_{b}) for storing the output voltage from the rectifier unit. The rectifier unit discloses as a full bridge circuit, but is not limited to thereto. The secondary side windings of the transformer 931 may comprise a first sub-winding and a second sub-winding, wherein the voltage supply unit 921 can be connected to the first sub-winding and the low side buck converter 936a and 936b can be connected to the second sub-winding.

The floating voltage (Vₕ) and the link voltage (V_{L}) are generated by an operation of the converter unit 930, after predetermined voltages (V_{b}) are charged to the capacitor (C_{b1}, C_{b2}) by the low side buck converters 936a and 936b, predetermined voltages (V_{b}) charged to the floating voltage (Vₕ) and the capacitors (C_{b1}, C_{b2}) are connected in serial each other, thereby the link voltage (V_{L}) enables the voltage corresponding to the sum of the floating voltage (Vₕ) and the predetermined voltages (V_{b}) to apply to the LED. Therefore, with the help of the floating voltage (Vₕ) with high voltage level, it is possible to output a voltage capable of driving the LED only by an operation of the low side buck converters 936a and 936b for inputting a small voltage and to largely reduce the voltage stress to size V_{L} of the link voltage (V_{L}).

In addition, the channel may be formed of a plurality of LEDs, which are connected in parallel as shown in FIG. 10.

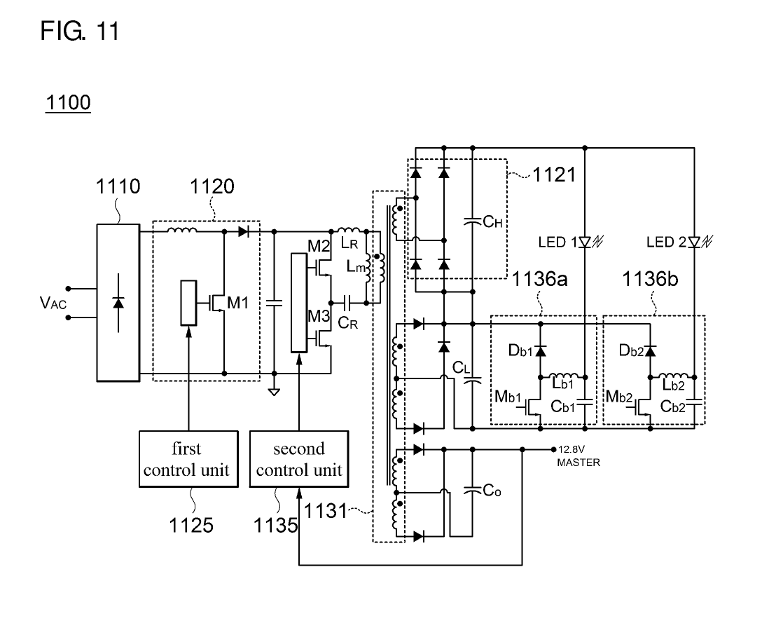

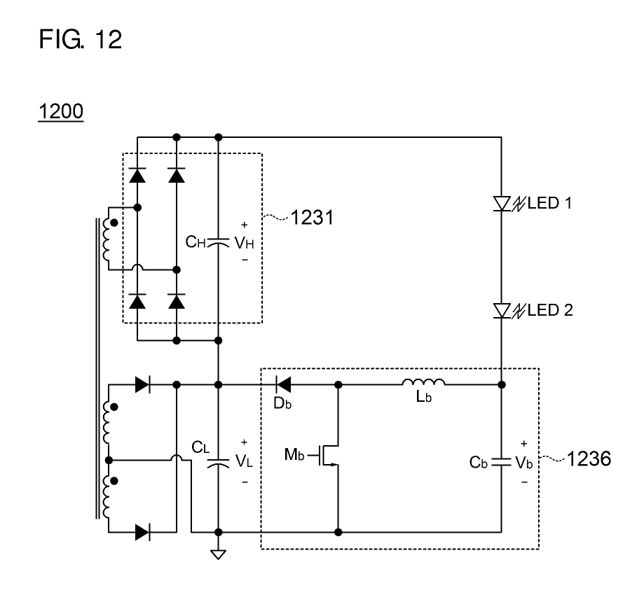

FIG. 11 is a circuit diagram showing a fourth embodiment of the power converter according to the present invention, and FIG. 12 is a circuit diagram showing a first embodiment for driving the serial single channel from the power converter shown in FIG. 11.

Referring to FIG. 11, a power converter 1100 may comprise a rectifier unit 1110, PFC 1120 and a converter unit 1130. The converter unit 1130 may comprise an LLC converter. In addition, booster converters 1136a and 1136b can be adapted to secondary side windings of transformer 1131 contained within the converter unit 1130. The number of the booster converters 1136a and 1136b can correspond to the number of channels. In addition, the converter unit 1130 is formed on the secondary side windings and may comprise a voltage supply unit 1121 for applying the floating voltage (Vₕ). The voltage supply unit 1121 may comprise a rectifier unit including diode and capacitor (C_{H}) for storing the output voltage from the rectifier unit. The rectifier unit discloses as a full bridge circuit, but is not limited to thereto. The secondary side windings of the transformer 1131 may comprise a first sub-winding and a second sub-winding, wherein the voltage supply unit 1121 can be connected to the first sub-winding and the booster converters 1136a and 1136b can be connected to the second sub-winding.

The floating voltage (Vₕ) and the link voltage (V_{L}) are generated by an operation of the converter unit 930, and when the driving of the converter unit 1130 is stopped, the booster converters 1136a and 1136b cannot be operated, and thus the predetermined voltages (V_{b}) can be corresponded to equation 2 and the LED can be turned off. And, when converter unit 1130 is driven, the booster converters 1136a and 1136b for inputting predetermined voltages (V_{b}) charged to the floating voltage (Vₕ) work and the booster converters 1136a and 1136b discharge the charges charged to the capacitor (C_{b}), and thereby the predetermined voltages (V_{b}) charged to the floating voltage (Vₕ) reduce to the voltage corresponding to said equation 3, as a result, the driving voltage (V_{LED}) can be applied to the LED and can drive the LED. Since the link voltage (V_{L}) is much lower than the driving voltage (V_{LED}), the present invention can also have an advantage capable of sufficiently reducing the voltage stress of all the elements of the booster converters 1136a and 1136b.

In addition, as shown in FIG. 12, the channel may be formed of a plurality of LEDs, which are connected in parallel as shown in FIG. 11.

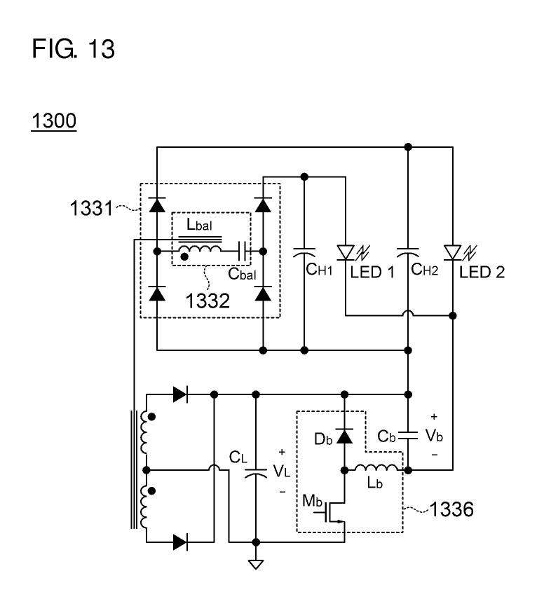

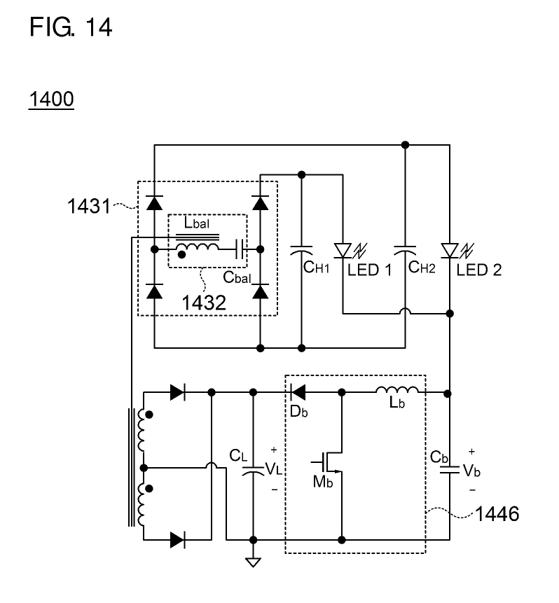

FIG. 13 is a circuit diagram showing a first embodiment of converter unit cap balancing using a capacitor in the two channels and FIG. 14 is a circuit diagram showing a second embodiment of converter unit cap balancing using a capacitor in the two channels.

As shown in FIG. 13, a converter unit 1300 can be provided with a low side buck converter 1336 at its secondary side, and as shown in FIG. 14, a converter unit 1400 can be provided with a booster converter 1446 at its secondary side.

Referring to FIG. 13, in the converter unit 1300, a balance unit 1332 can be connected in a rectifier unit 1331. Even though the driving voltages of first and second channels differ from each other by the balance unit 1332, the converter unit 1300 can uniform the voltage applied to the first channel and second channel. The balance units 1332 and 1432 may comprise a balance cap (C_{bal}) and a balance inductor (L_{bal}). In addition, the balance cap (C_{bal}) can be connected to the balance inductor (L_{bal}) in parallel. In the converter unit 1400 shown in FIG. 14, the balance units 1432 can be connected to a rectifier unit 1441 in the same way as the balance unit 1332 shown in FIG. 13.

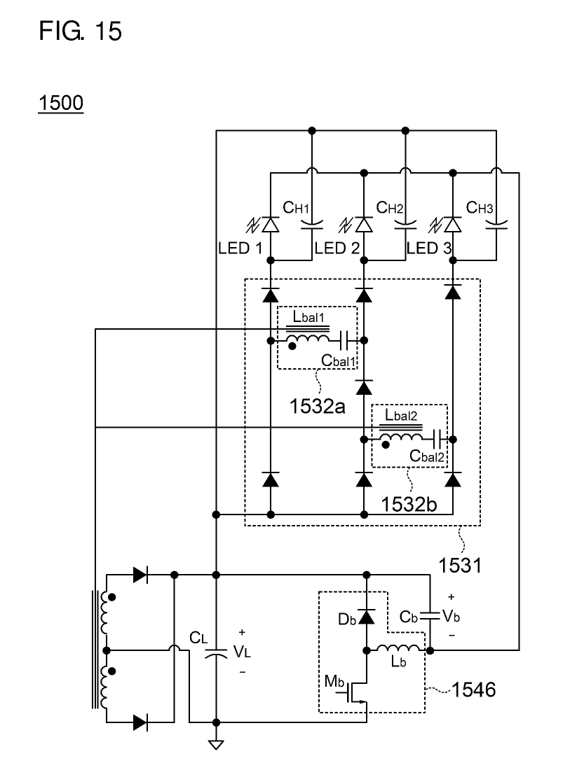

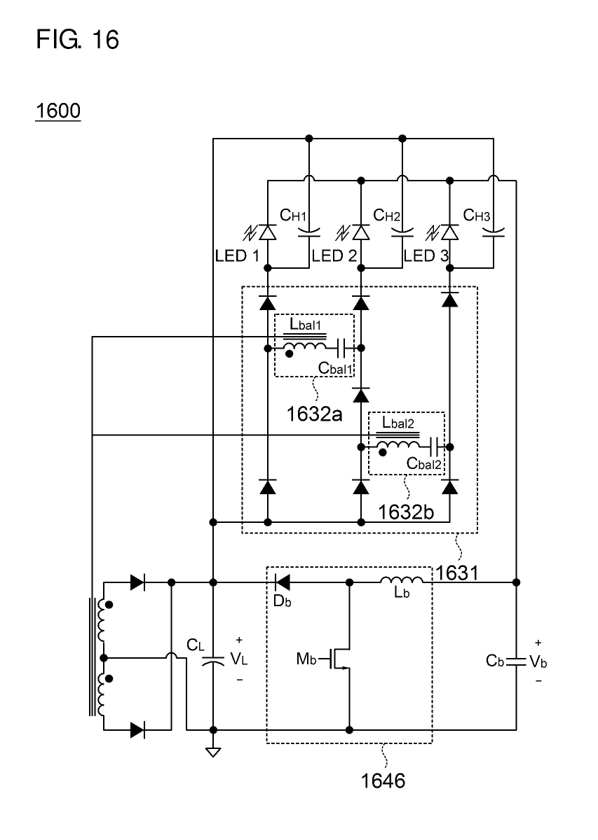

FIG. 15 is a circuit diagram showing a first embodiment of converter unit cap-balancing using a capacitor in the three channels, and FIG. 16 is a circuit diagram showing a second embodiment of converter unit cap-balancing using a capacitor in the three channels.

Referring to FIG. 15, a rectifier unit 1531 of a converter unit 1500 may comprise a first balance unit 1532a and a second balance unit 1532b. The first balance unit 1532a can be connected to a portion of supplying current to the first channel and the second channel, and the second balance unit 1532b can be connected to a portion of supplying current to the second channel and a third channel. In addition, each of the first balance unit 1532a and second balance unit 1532b may comprise a balance cap (C_{bal}) and a balance inductor (L_{bal}). The balance cap (C_{bal}) can be connected to the balance inductor (L_{bal}) in parallel. In addition, in the converter unit 1600 shown in FIG. 16, a first balance unit 1632a and a second balance unit 1632b can be connected to a rectifier unit 1631 in the same way as the first balance unit 1532a and the second balance unit 1532b shown in FIG. 15.

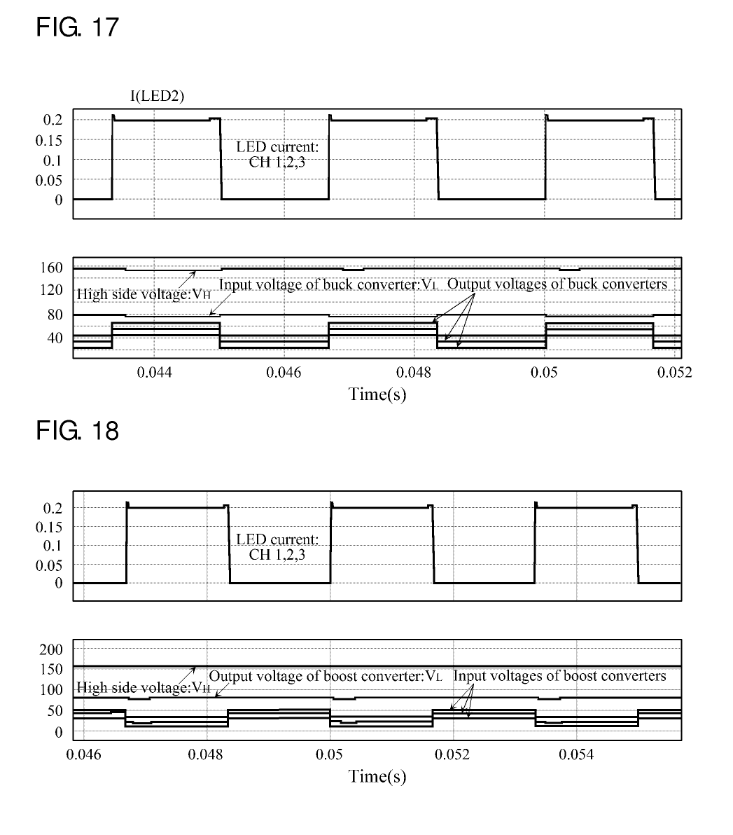

FIG. 17 is a graph showing the experimental results in case where the low-side buck converter is applied to the secondary-side of the LLC converter.

Referring to FIG. 17, the simulation test results studied by a PSIM simulation tool are shown. The input voltage is DC 390 V and comprises three channels, forward voltage (V_{f}) applied to each of channels has a deviation of 180V, 190V and 200V and the equivalent resistance can be 1000. In addition, the power converter can have 50% dimming. All the power converters have precisely controlled 200 mA under the circumstances that the deviation is presented in the forward voltage (V_{f}). Also LED can be driven with the voltage of about 220V degree, but the input voltage of the buck converter is low at most 78V degree so that the inner voltage of a used semiconductor has also shown maximum 78V.

FIG. 18 is a graph showing the experimental results in case where the booster converter is applied to the secondary-side of the LLC converter.

Referring to FIG. 18, the driving circuit comprises the suggested three (3) channels which are applied to the booster converter in case of 50 dimming, and the driving circuit has also precisely controlled 200 mA at the three channels under the circumstances that the deviation is present in the forward voltage (V_{f}). Also the LED can be driven with the voltage of about 220V degree, but the output voltage of the booster converter is low at most 78V degree so that the inner voltage of a used semiconductor also has shown maximum 78V. In addition, it can be seen that when the booster converter is turned on dimming, the input voltage of the booster converter is decreased and thus the voltage applied to the LED is increased so as to drive the LED, and when turned off dimming, the input voltage of the booster converter is increased by stopping an operation of the booster converter and the LED is turned off.

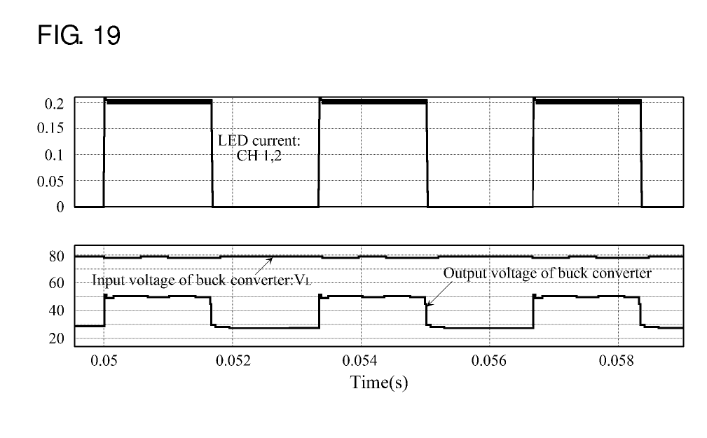

FIG. 19 is a graph showing the experimental results in case where a low-side buck converter is applied to the secondary-side of the LLC and cap balancing using a capacitor in the two channels.

Referring to FIG. 19, a balance unit of the suggested two channels applied to the low-side buck converter has precisely controlled 200 mA at the three channels under the circumstances that the deviation is present in the forward voltage (V_{f}). That is, it can be seen that the sum of LED current of two channels is controlled by the low-side buck converter and the current balancing between the LEDs is maintained by the balance unit. Also the LED can be driven with the voltage of about 220V degree, but the input voltage of the converter is low at most 78V degree so that the inner voltage of used semiconductor also has shown maximum 78V.

The functions of the various elements shown in the drawings may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

In the claims hereof, any element expressed as a means for performing a specified function is intended to encompass any way for performing that function including, for example, a combination of circuit elements which performs that function or software in any form, including, therefore, firmware, microcode or the like, combined with appropriate circuitry for executing that software to perform the function.

Reference in the specification to “an embodiment” of the present principles, as well as other variations thereof, means that a particular feature, a structure, a characteristic, and so forth described in connection with the embodiment is included in at least one embodiment of the present principles. Thus, the appearances of the phrase “in an embodiment”, as well as any other variations, appearing in various places throughout the specification are not necessarily all referring to the same embodiment.

Reference in the specification to “connected” or “connecting”, as well as other variations thereof, means that an element is directly connected to the other element or indirectly connected to the other element through another element. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

What is claimed is:

1. A power converter for applying a voltage to a load including at least one channel comprising:
a power supply for storing and outputting a floating voltage lower than a forward voltage of the channel; and
a converter for receiving and converting a link voltage to generate a first voltage;
wherein the summed voltage of the floating voltage and the first voltage is transmitted to the load.

2. The power converter according to claim 1, wherein the summed voltage of the floating voltage and the first voltage is higher than the forward voltage of the channel.

3. The power converter according to claim 1, wherein the converter comprises an inductor, a first switch and a first capacitor, wherein the first switch adjusts a current flowing through the inductor by performing a switching operation, to convert the link voltage and generate the first voltage.

4. The power converter according to claim 1, further comprising a transformer comprising a first side winding and a second side winding, wherein the second side winding of the transformer comprises a first sub-winding and a second sub-winding, a voltage corresponding to the floating voltage is inducted from the first sub-winding and a voltage corresponding to the link voltage is inducted from the second sub-winding.

5. The power converter according to claim 1, wherein the load comprises at least a first channel and a second channel connected in parallel, and the converter is a plurality of converters where each of the converters converts the link voltage into the first voltage.

6. The power converter according to claim 5, further comprising a transformer comprising a first side winding and a second side winding, wherein the second side winding of the transformer comprises a first sub-winding and a second sub-winding, a voltage corresponding to the floating voltage is inducted from the first sub-winding and a voltage corresponding to the link voltage is inducted from the second sub-winding.

7. The power converter according to claim 6, wherein a first rectifier unit is connected to the first sub-winding and a second rectifier unit is connected to the second sub-winding, and the floating voltage is output from the first rectifier unit and the link voltage is output from the second rectifier unit.

8. The power converter according to claim 7, wherein the first rectifier unit further comprises a balance unit for decreasing a deviation of the current flowing through the first channel and the second channel, respectively.

9. The power converter according to claim 8, wherein the balance unit comprises a balance cap and a balance inductor connected to the balance cap.

10. The power converter according to claim 1, wherein the power supply comprises a floating capacitor for storing a predetermined voltage.

11. The power converter according to claim 1, wherein the converter comprises a buck converter.

12. A power converter for applying a voltage to a load including at least one channel comprising:
a capacitor in serial connected to the channel; and
a converter for dividing an input voltage into a link voltage and a floating voltage lower than a forward voltage of the channel and converting the link voltage and adjusting the input voltage into the capacitor,
wherein the converter enables a first voltage to apply to the capacitor on stopping and a voltage lower than the forward voltage of the channel to apply to the channel, and a second voltage to charge to the capacitor by discharging the first voltage on driving and a voltage higher than the forward voltage of the channel to apply to the channel.

13. The power converter according to claim 12, wherein the converter comprises an inductor and a first switch, wherein the first switch performs a switching operation and adjusts a voltage applied to the inductor and thereby to charge the second voltage to the capacitor.

14. The power converter according to claim 12, further comprising a transformer comprising a first side winding and a second side winding, wherein the second side winding of the transformer comprises a first sub-winding and a second sub-winding, a voltage corresponding to the floating voltage is inducted from the first sub-winding and a voltage corresponding to the link voltage is inducted from the second sub-winding.

15. The power converter according to claim 13, wherein the load comprises at least a first channel and a second channel connected in parallel, and the capacitor and the converter are in plural in number, wherein each converter is to charge the second voltage to each capacitor.

16. The power converter according to claim 15, further comprising a transformer comprising a first side winding and a second side winding, wherein the second side winding of the transformer comprises a first sub-winding and a second sub-winding, a voltage corresponding to the floating voltage is inducted from the first sub-winding and a voltage corresponding to the link voltage is inducted from the second sub-winding.

17. The power converter according to claim 16, wherein a first rectifier unit is connected to the first sub-winding and a second rectifier unit is connected to the second sub-winding and wherein the floating voltage is output from the first rectifier unit and the link voltage is output from the second rectifier unit.

18. The power converter according to claim 17, wherein the first rectifier unit further comprises a balance unit for decreasing a deviation of the current flowing through the first channel and the second channel, respectively.

19. The power converter according to claim 18, wherein the balance unit comprises a balance cap and a balance inductor connected to the balance cap.
